(19) United States
(12) Patent Application Publication
(10) Pub. No.: US 2017/0295988 A1
(43) Pub. Date: Oct. 19, 2017

(54) CAPSULE BEVERAGE BREWING SYSTEM

(71) Applicant: Chin-Kuo Chung, Taipei (TW)

(72) Inventor: Chin-Kuo Chung, Taipei (TW)

(21) Appl. No.: 15/132,249

(22) Filed: Apr. 19, 2016

(51) Int. Cl. A47J 31/40; A47J 31/44

(52) U.S. Cl. CPC A47J 31/407; A47J 31/4403; A47J 31/4492

(57) ABSTRACT

A capsule beverage brewing system includes: a brewer body having an accommodating space, and a sensing device and a sensor installed on an inner surface of the brewer body; at least one capsule containing a concentrated beverage and having an identification code on an outer surface of the capsule and corresponsive to the type of beverage contained in the capsule; and a tray installed in the brewer body and having an accommodating portion for disposing the capsule, and a contact portion extended from a side of the tray, such that when the tray is pushed into the accommodating space, the contact portion pushes or presses the sensor for a brewing operation. The brewing system automatically identifies the type of capsule, so that users need not to adjust any brewing parameters to obtain a good tasted beverage in the brewing process.

### BACKGROUND OF THE INVENTION

### 1. Field of the Invention

The present invention relates to the field of beverage brewers, and more particularly to a capsule beverage brewing system capable of automatically identifying the type of a capsule and brewing a beverage contained in the capsule.

### 2. Description of the Related Art

In the field of daily consuming products, beverage makers provided for consumers to make a fixed type of beverage has been used extensively. As the quality of life improves, consumers has an increasingly higher demand for beverages such as coffee and tea; as our lifestyle changes, the conventional multi-cup beverage brewers are gradually replaced by the capsule beverage brewers.

A general capsule beverage brewer uses components such as blades or fluid injectors to pierce the top surface of a capsule to fill in hot water, and a compressing device is added to the bottom of the capsule or another single-needle piercing mechanism is installed additionally, so that the beverage such as coffee may flow out from the bottom of the capsule. However, there are various types or tastes of beverages requiring different brewing conditions, so that consumers have to input necessary information according to the brewing conditions for the brewing process, and thus causing inconvenience of brewing beverages, and even taking much more time for correction when pushing a wrong button. Even though there are capsule beverage brewers available in the market, these brewers do not have a mechanism for collecting users' preferred beverages, and manufacturers are unable to learn whether or not the present selling beverages meet the users' preference, and thus spending unnecessary costs on selling products of a low degree of purchase.

In view of the aforementioned problems of the conventional beverage brewers, the inventor of the present invention based on years of experience in the related industry to conduct extensive researches and experiments and finally developed a capsule beverage brewing system to improve the problems of the prior art.

### SUMMARY OF THE INVENTION

Therefore, it is a primary objective of the present invention to provide a capsule beverage brewing system having a mechanism for automating determining the type of a beverage and brewing the beverage, so that users no longer need to adjust the brewing parameters in a brewing process in order to drink a better tasted beverage. In addition, the system is capable of actively collecting the users' drinking preference and reducing the cost for market survey and the selling quantity of products with a low degree of purchase, so as to lower the selling cost indirectly.

To achieve the aforementioned and other objectives, the present invention provides a capsule beverage brewing system for brewing a capsule containing a beverage material, and the capsule beverage brewing system comprises: a brewer body, having an accommodating space, a sensing device installed on an inner surface of the brewer body, a processing module, and a database, and the processing module and the database being telecommunicatively coupled to each other, and the processing module having a data collection unit for recording the type of beverage of the capsule used for brewing each time; and a server, telecommunicatively coupled to the brewer body, for informing a manufacture to know the drinking condition of each type of capsule beverages after the data collection unit has transmitted the stored data to the server.

In use, a surface of the capsule used by the capsule beverage brewing system has an identification code configured to be corresponsive to the type of beverage contained in the capsule, such that when the brewer body starts a brewing operation, the sensing device detects the identification code on the capsule placed on the brewer body and then transmits a detection result to the processing module, and the processing module identifies the type of beverage contained in the capsule according to the detection result, and searches for a corresponsive beverage brewing method in the database according to an identification result, and the processing module drives the brewer body to brew the beverage according to the searched brewing method.

Wherein, the present invention further comprises a tray, and an inner surface of the brewer body further having a plurality of rails and a sensor, and the tray being installed in the brewer body and movably embedded into the rails, so that the tray may slide out from the accommodating space or slide into the accommodating space, and the tray having an accommodating portion for disposing a capsule, and a contact portion being formed and extended from a side of the tray, such that when the tray is pushed into the accommodating space, the contact portion pushes or presses the sensor to perform a brewing operation.

In addition, the brewer body includes a touch screen for displaying the current brewing status, and the touch screen is provided for a user to manually adjust the amount of water and the brewing time in a brewing process.

Preferably, the server transmits a message to the touch screen for the user's view or interaction to achieve the commercial effects for promoting and advertising products.

Preferably, the accommodating portion has a first disposition area and a second disposition area, and the second disposition area is disposed in the first disposition area, and the first disposition area and the second disposition area are of different shapes and provided for disposing capsules of different shapes.

Preferably, the brewer body further includes a cup placement portion having a pressure detector for detecting the weight of a cup disposed at the cup placement portion. In addition, the processing module includes a computing unit, a comparing unit and a warning unit, and each brewing method stored in the database provides an estimated weight corresponsive to each type of beverage, so that after the pressure detector detects the weight of an empty cup and returns data to the computing unit, the computing unit obtains total weight data by adding the weight of the empty cup to the estimated weight of the beverage and transits the total weight data to the comparing unit, and during the brewing process, the pressure detector keeps transmitting the detected weight to the comparing unit, and the comparing unit keeps comparing the detected weight with the total weight, and if there is a match, then a signal will be transmitted to the warning unit, and the warning unit will be driven to transmit a signal to notify a user that the brewing process of the beverage is completed.

Preferably, the tray further includes a weight sensing unit telecommunicatively coupled to the processing module for sensing the weight of the capsule, so that the users can know whether or not the capsule has been deteriorated or moistened after being opened according a change of the weight of the capsule.

Preferably, the brewer body further includes a pressure detecting unit telecommunicatively coupled to the processing module for detecting the atmospheric pressure outside the brewer body, so that the processing module can balance the internal pressure and maintain the taste of the brewed beverage according to the external atmospheric pressure.

Preferably, the brewer body further includes a light sensing unit telecommunicatively coupled to the processing module for sensing the light intensity outside the brewer body.

Preferably, the brewer body further includes a position detecting unit telecommunicatively coupled to the processing module for detecting the position of the brewer body.

Preferably, the sensing device is installed in an isolated box for preventing the external environment from affecting the sensing device.

Therefore, the present invention can know the type of beverage contained in the capsule by automatically identifying the identification code of the capsule, and the brewer will search for a brewing method in the database according to the identified type of beverage type in the database and will automatically brew the beverage according to the brewing method, so that the users no longer need to set the brewing conditions in order to drink a good brewed beverage, reduce the possibility of pressing a wrong button, and further provides a simple and easy brewing system. The present invention may also connects the brewer to a cloud server to transmit data of the drinking habit (such as the most favorable favor of the capsule beverage) of the users of the brewer to the server, in order to reduce the manufacturer's cost for market survey, and the server may transmit interactive messages to the screen of the brewer in order to provide more information to the users.

### BRIEF DESCRIPTION OF THE DRAWINGS

FIG. 1 is a schematic view showing the interior of a brewer of a first embodiment of the present invention;

FIG. 2 is an exploded view of the first embodiment of the present invention;

FIG. 3 is a system block diagram of the first embodiment of the present invention;

FIG. 4 is a schematic view of a tray of the first embodiment of the present invention;

FIG. 5 is a block diagram of a second embodiment of the present invention;

FIG. 6 is a first schematic view of using the second embodiment of the present invention; and

FIG. 7 is a second schematic view of using the second embodiment of the present invention.

### DESCRIPTION OF THE PREFERRED EMBODIMENTS

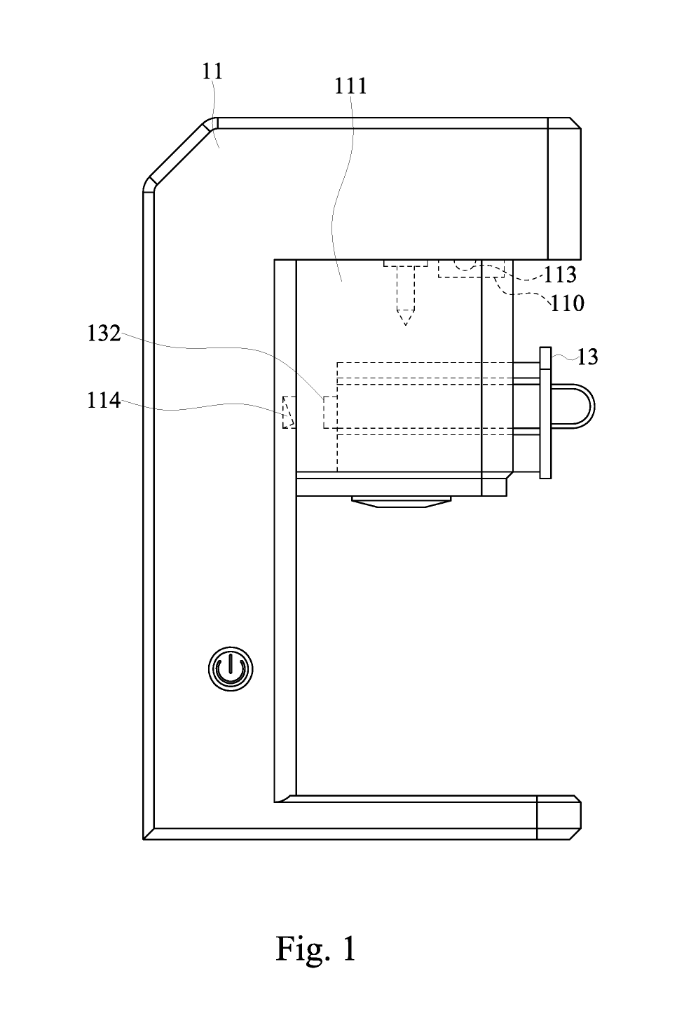

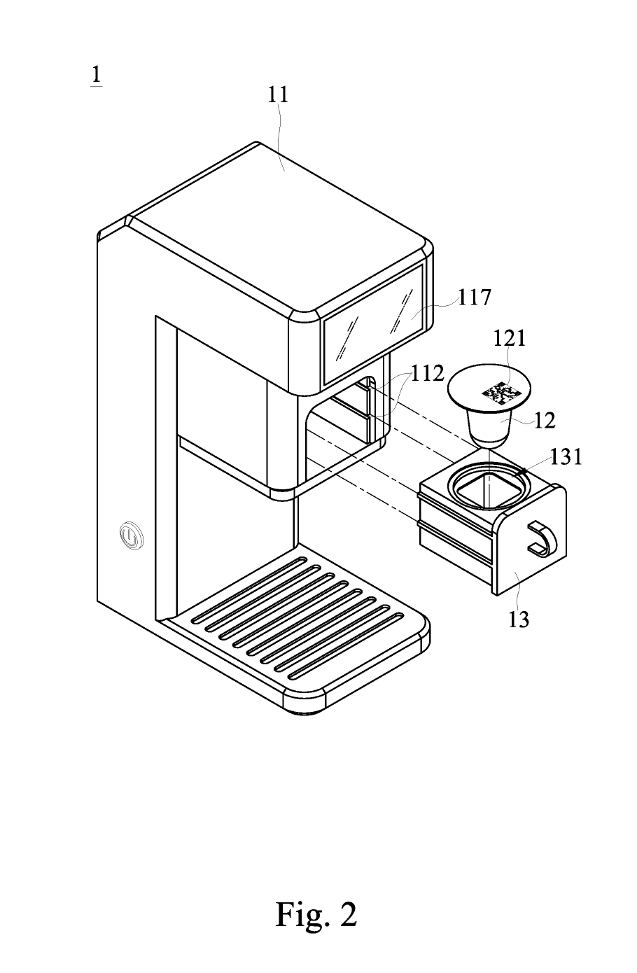

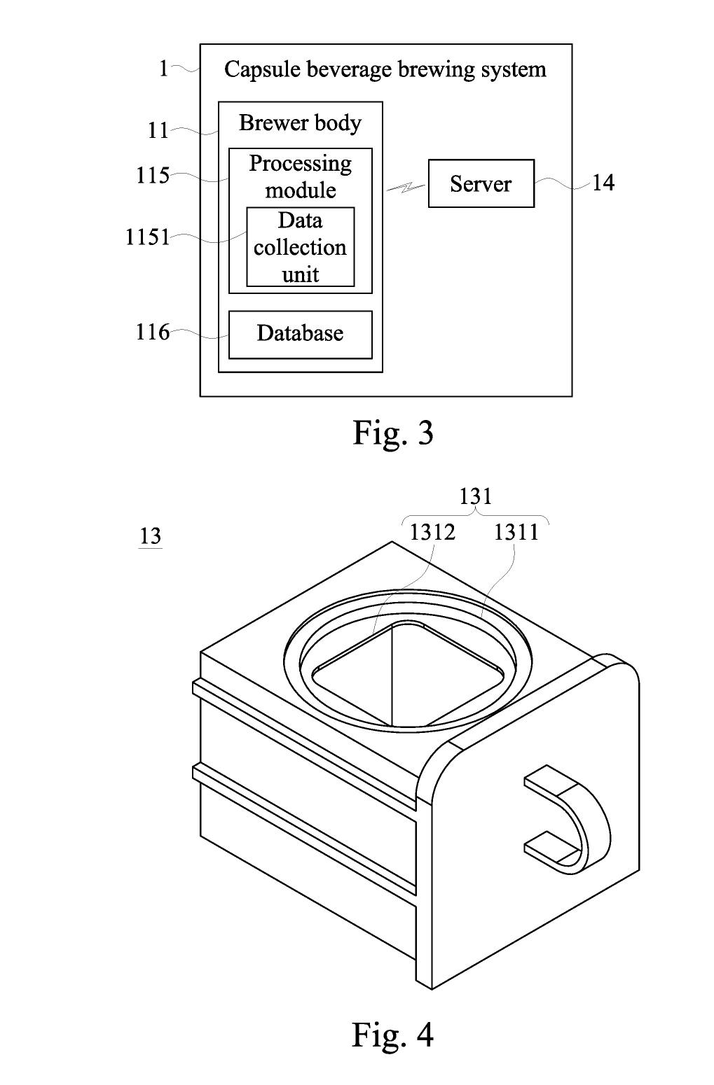

With reference to FIGS. 1 to 3 for schematic views showing the interior of a brewer, an exploded view, and a system block diagram of the first embodiment of the present invention respectively, the present invention provides a capsule beverage brewing system 1 comprising a brewer body 11 and a tray 13, and the capsule beverage brewing system 1 is provided for brewing a capsule 12 containing a concentrated beverage.

The brewer body 11 has an accommodating space 111, a plurality of rails 112, a sensing device 113 and a sensor 114. In this embodiment, the sensing device 113 is installed in an isolated box 110 for isolating moisture and preventing moisture from entering into the sensing device 113 or damaging the sensing device 113. Wherein, the rails 112, the sensing device 113 and the sensor 114 are disposed in the accommodating space 111. The brewer body 11 has a processing module 115 and a database 116, and the processing module 115 and the database 116 are telecommunicatively coupled to each other. The outer surface of the capsule 12 has an identification code 121, wherein the identification code 121 is installed in corresponsive to the type of beverage contained the capsule 12. In this embodiment, QR code is used for illustrating the invention, but the invention is not limited to QR code. The tray 13 is installed in the brewer body 11 and movably latched to the rails 112, so that the tray 13 may slide out from the accommodating space 111 or slide into the accommodating space 111, wherein the tray has an accommodating portion 131 for disposing the capsule 12 and a contact portion 132 is formed and extended from a side of the tray 13 and provided for pushing or pressing the sensor 114 to perform the brewing operation when the tray 13 is pushed into the accommodating space 111.

When use, a user puts the capsule 12 onto the accommodating portion 131 of the tray 13 and then pushes the tray 13 into the accommodating space 111 until the contact portion 132 pushes or presses the sensor 114 to start the brewer body 11, and the sensing device 113 is turn on to start detecting the identification code 121 on the capsule 12 and transmit a detection result to the processing module 115, and the processing module 115 identifies the type of beverage contained in the capsule 12 according to the detection result, and the processing module 115 searches for a beverage brewing method in the database 116 according to the identification result, and then the processing module 115 drives the brewer body 11 to brew the beverage automatically according to the searched brewing method. With the present invention, the users no longer need to input different brewing setup conditions after putting in the capsule 12 and simply pressing a button to start the brewing procedure, and the invention can prevent the users from pressing a wrong button or pressing the same button for many times that gives a bad tasted beverage.

In this embodiment, the present invention may have a server 14 installed at a cloud or a remote end and telecommunicatively coupled to the brewer body 11, and the processing module 115 has a data collection unit 1151 for recording the type of beverage contained in the capsule 12 for each time of brewing, and then transmitted the stored data to the server 14 provided for a manufacturer to know about the drinking status of various types of capsule beverages. By such feedback mechanism, the manufacturer can save the cost of market survey and obtain more accurate surveys than the conventional questionnaire, so that the manufacturer can quickly adjust the marketing strategy according to the users' preference, and further reduces the production of products with a low degree of purchase, the inventory of bad selling products, and additional costs. Since the server 14 can save the information of user's purchase preference for the capsule 12, therefore the users may inquire information via the server 14 to learn about others' preference and use the information for reference for their purchase.

In this embodiment, the brewer body 11 further includes a touch screen 117 for displaying the current brewing status, such that after the processing module 115 has searched a brewing method in the database 116, the processing module 115 will display the brewing method on the touch screen 117. If a user does not like the detailed parameters of such brewing method stored in the database 116, the user may manually adjust the parameters such as the amount of water and the brewing time through the touch screen 117 in order to change the taste of the finally brewed beverage. If the brewing method is acceptable or the user has not performed any operation on the touch screen 117 for a certain period of time, then the processing module 115 will automatically drive the brewer body 11 to brew the beverage according to the selected brewing method. In addition, if the sensing device 113 cannot identify the identification code 121 on the capsule 12, the user may operate the touch screen 117 manually to achieve the effects of brewing the beverage and preventing the failure of brewing the beverage when the brewer fails to identify the identification code 121. In addition, the server 14 may transmit a message to the touch screen 117, wherein the message may be an advertisement, a sale promotion or an interactive game provided for the users' view or interaction, so as to achieve the commercial effects of advertising and promotion. The user does not have to boringly stand in front of the brewer body 11 and wait to the end of the brewing process. The message displayed on the touch screen 117 allows the user to eliminate the boredom of waiting for the brewing time. As to the manufacturers, the messages such as the advertisement can be sent to the user end to obtain commercial benefits.

With reference to FIG. 4 for a schematic view of a tray in accordance with the first embodiment of the present invention, the accommodating portion 131 on the tray 13 has a first disposition area 1311 and a second disposition area 1312, wherein the second disposition area 1312 is disposed in the first disposition area 1311, and the first disposition area 1311 and the second disposition area 1312 are of different shapes. In this embodiment, the first disposition area 1311 is in a circular shape, and the second disposition area 1312 is in a square shape, and both disposition areas 1311, 1312 are provided for disposing the capsules 12 of different shapes. Since the capsule 12 may be designed with a different shape freely according to a change of brands or types, and the design of the first disposition area 1311 and the second disposition area 1312 allows the tray 13 to hold the capsules 12 of different shapes, so as to prevent the capsule 12 of a certain brand from failing to match the shape of the capsule of a user's favorable brand or spending extra costs to buy an additional brewer.

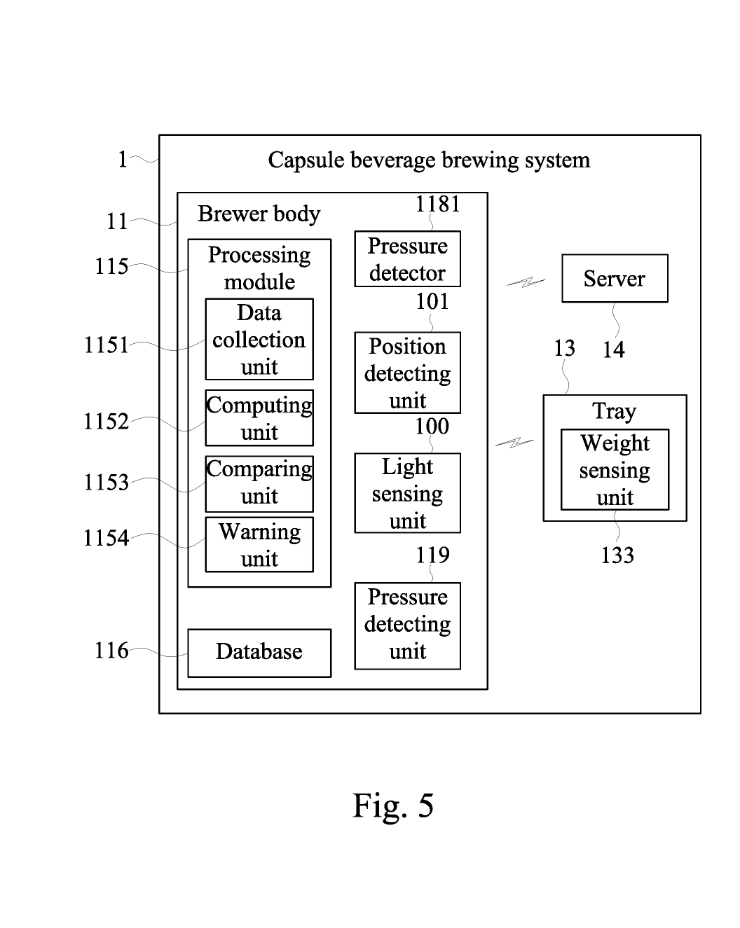

With reference to FIGS. 5 to 7 for a block diagram, a first schematic view and a second schematic view of the second embodiment of the present invention respectively, the brewer body 11 of this embodiment further includes a cup placement portion 118 having a pressure detector 1181 for detecting the weight of a cup placed on the cup placement portion 118. In addition, the processing module 115 includes a computing unit 1152, a comparing unit 1153 and a warning unit 1154, wherein each brewing method stored in the database 116 provides an estimated weight of beverage for each type of beverage, and such estimated weight mainly changes with the amount of filled water. If a user changes the amount of filled water through the touch screen 117, the estimated weight will be changed accordingly. In addition, the tray 13 further includes a weight sensing unit 133 telecommunicatively coupled to the processing module 115 for sensing the weight of the capsule 12, and each brewing method stored in the database 116 further provides a default weight corresponsive to each capsule 12, so that the user can compare the default weight with the actually inputted weight of the capsule 12 in order to check if there is any change of the weight and know whether or not the inputted capsule 12 has been deteriorated or moistened after being opened. In addition, the brewer body 11 further includes a pressure detecting unit 119 telecommunicatively coupled to the processing module 115 for detecting the atmospheric pressure outside the brewer body 11, and each brewing method in the database 116 provides a default brewing pressure corresponsive to each type of beverage type, so that the processing module 115 can balance the internal pressure according to the external atmospheric pressure to maintain the good taste of the brewed beverage. The remaining components are the same as those of the first embodiment and thus will not be described again.

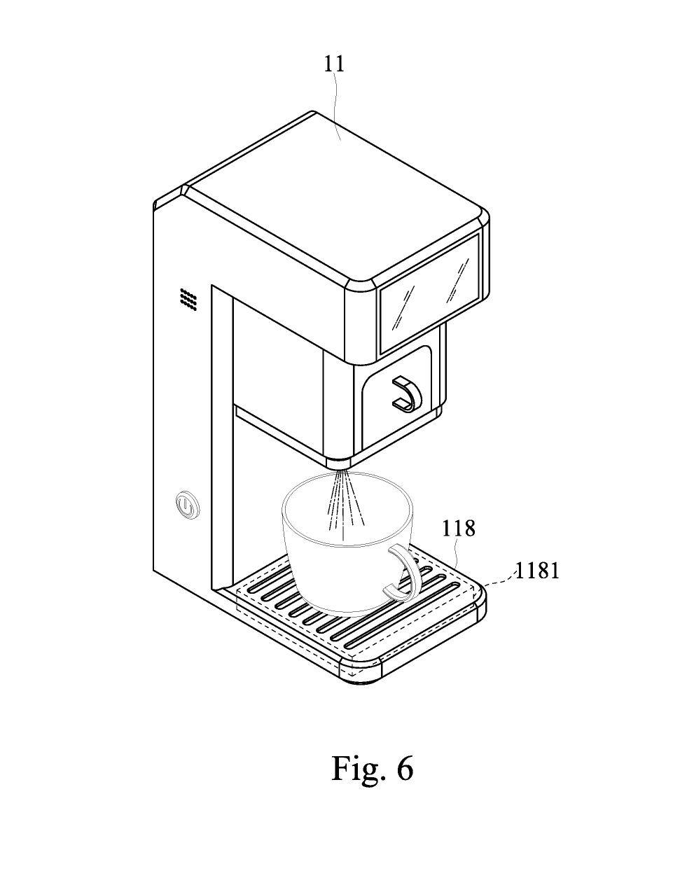

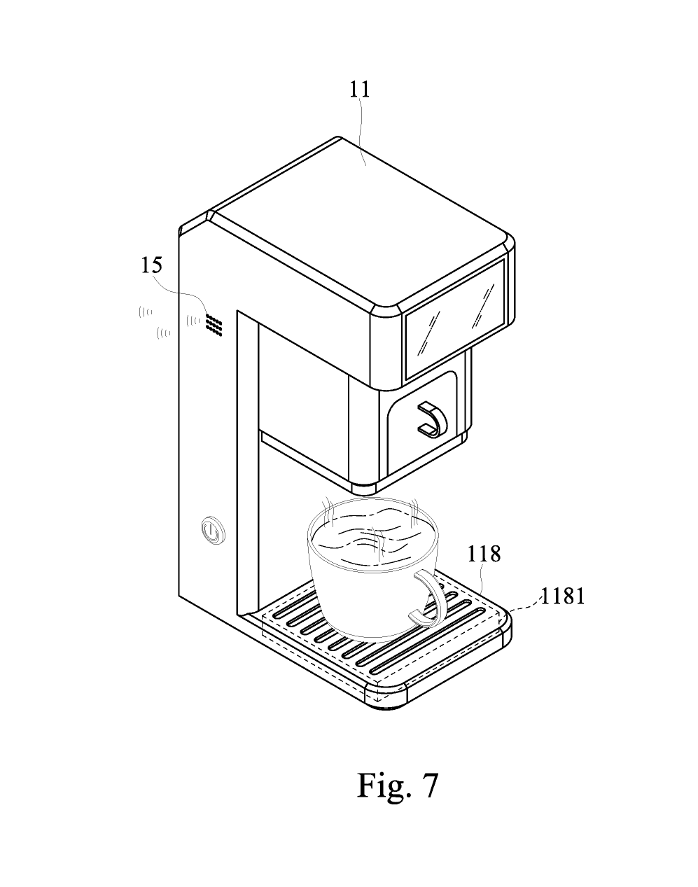

In use, the weight sensing unit 133 detects the weight of the capsule 12 placed on the accommodating portion 131 after the identification code 121 is identified, and transmits the weight to the comparing unit 1153 for comparison. If there is a match, then the brewing process will continue, and the pressure detecting unit 119 will start detecting the atmospheric pressure outside the brewer body 11. If the pressure does not match with the default pressure, then the processing module 115 will adjust the internal pressure to match the default pressure, so that a change of air pressure will not affect the final taste of the brewed beverage. Then, the user may put the cup on the cup placement portion 118 and start a brewing operation. After the brewing operation has started, the pressure detector 1181 detects the weight of an empty cup, and return data to the computing unit 1152, and the computing unit 1152 obtains an estimated weight of a beverage the database 116 according to the identified type of beverage, and then adds the weight of the empty cup to the estimated weight to obtain the data of a total weight. After the total weight is transmitted to the comparing unit 1153, the comparing unit 1153 drives the brewer body 11 to start filling water to brew the beverage. In the brewing process as shown in FIG. 6, the brewer body 11 keeps filling the brewed beverage into the cup, and the pressure detector 1181 keeps transmitting the detected weight of the beverage added into the cup to the comparing unit 1153, and the comparing unit 1153 keeps comparing the detected weight with the total weight, and if there is a match, the brewer body 11 will consider that the brewing procedure has completed. Now, the comparing unit 1153 sends a signal to the warning unit 1154 and drives the warning unit 1154 to issue a signal to notify a user that the brewing process of the beverage is completed, so that users will not forget the matter of brewing the beverage by the brewer body 1 if they are doing something else while waiting for the beverage. The signal issued by the warning unit 1154 can timely notify the users and let the users drink the brewed beverage at the best time. In this embodiment, the brewer body 11 further has a sound output hole 15, and the warning unit 1154 transmits sound through the sound output hole 15 to remind the users as shown in FIG. 7.

In addition, the present invention may add a light sensing unit 100 and a position detecting unit 101, wherein the light sensing unit 100 is provided for sensing the light intensity outside the brewer body 11 to notify the processing module 115 to adjust the brightness of the touch screen 117, and the position detecting unit 101 is provided for detecting the position of the brewer body 11 and transmitting the position information to the processing module 115, and the processing module 115 further transmits the position information to the server 14, so that the manufacturer can deliver related products to users according to the position information.

By the aforementioned method and structure, the present invention can automatically identify the identification code 121 of the capsule 12 and know what beverage is contained in the capsule 12, and the processing module 115 searches for a brewing method in the database 116 according to the identified type of beverage to drive the brewer body 11 to brew the beverage according to the selected brewing method, so that the users no longer need to input brewing setup parameters to obtain the brewed beverage, and the invention can lower the possibility of performing a wrong operation. The present invention further connects the brewer body 11 to a cloud server 14 to transmit data of the most favorable capsule beverage and the drinking habit of a user to the server 14 in order to indirectly reduce the manufacturer's cost for market survey, and the server 14 may broadcast interactive messages to the touch screen 117 of the brewer body 11 to allow the users to obtain more information.

What is claimed is:

1. A capsule beverage brewing system, for brewing a capsule containing a concentrated beverage, and the capsule beverage brewing system comprising:
a brewer body, having an accommodating space, a sensing device installed on an inner surface of the brewer body, a processing module, and a database, and the processing module and the database being telecommunicatively coupled to each other, and the processing module having a data collection unit for recording the type of beverage of the capsule used for brewing each time; and
a server, telecommunicatively coupled to the brewer body for informing a manufacture to know the drinking condition of each type of capsule beverages after the data collection unit has transmitted the stored data to the server;
wherein, a surface of the capsule used by the capsule beverage brewing system has an identification code configured to be corresponsive to the type of beverage contained in the capsule, such that when the brewer body starts a brewing operation, the sensing device detects the identification code on the capsule placed on the brewer body and then transmits a detection result to the processing module, and the processing module identifies the type of beverage contained in the capsule according to the detection result, and searches for a corresponsive beverage brewing method in the database according to an identification result, and the processing module drives the brewer body to brew the beverage according to the searched brewing method.

2. The capsule beverage brewing system according to claim 1, wherein the brewer body includes a touch screen for displaying the current brewing status, and the touch screen is provided for a user to manually adjust the amount of water and the brewing time in a brewing process.

3. The capsule beverage brewing system according to claim 2, wherein the server transmits a message to the touch screen for the user's view or interaction.

4. The capsule beverage brewing system according to claim 3, further comprising a tray, and an inner surface of the brewer body further having a plurality of rails and a sensor, and the tray being installed in the brewer body and movably embedded into the rails, so that the tray may slide out from the accommodating space or slide into the accommodating space, and the tray having an accommodating portion for disposing a capsule, and a contact portion being formed and extended from a side of the tray, such that when the tray is pushed into the accommodating space, the contact portion pushes or presses the sensor to perform a brewing operation.

5. The capsule beverage brewing system according to claim 4, wherein the accommodating portion has a first disposition area and a second disposition area, and the second disposition area is disposed in the first disposition area, and the first disposition area and the second disposition area are of different shapes and provided for disposing capsules of different shapes.

6. The capsule beverage brewing system according to claim 5, wherein the brewer body further includes a cup placement portion having a pressure detector for detecting the weight of a cup disposed at the cup placement portion.

7. The capsule beverage brewing system according to claim 6, wherein the processing module includes a computing unit, a comparing unit and a warning unit, and each brewing method stored in the database provides an estimated weight corresponsive to each type of beverage, so that after the pressure detector detects the weight of an empty cup and returns data to the computing unit, the computing unit obtains total weight data by adding the weight of the empty cup to the estimated weight of the beverage and transits the total weight data to the comparing unit, and during the brewing process, the pressure detector keeps transmitting the detected weight to the comparing unit, and the comparing unit keeps comparing the detected weight with the total weight, and if there is a match, then a signal will be transmitted to the warning unit, and the warning unit will be driven to transmit a signal to notify a user that the brewing process of the beverage is completed.

8. The capsule beverage brewing system according to claim 7, wherein the tray further includes a weight sensing unit telecommunicatively coupled to the processing module for sensing the weight of the capsule.

9. The capsule beverage brewing system according to claim 8, wherein the brewer body further includes a pressure detecting unit telecommunicatively coupled to the processing module for detecting the atmospheric pressure outside the brewer body.

10. The capsule beverage brewing system according to claim 9, wherein the brewer body further includes a light sensing unit telecommunicatively coupled to the processing module for sensing the light intensity outside the brewer body.

11. The capsule beverage brewing system according to claim 10, wherein the brewer body further includes a position detecting unit telecommunicatively coupled to the processing module for detecting the position of the brewer body.

12. The capsule beverage brewing system according to claim 11, wherein the sensing device is installed in an isolated box for preventing the external environment from affecting the sensing device.
